(19) United States
(12) Patent Application Publication
(10) Pub. No.: US 2009/0146770 A1
(43) Pub. Date: Jun. 11, 2009

(54) PLANAR-LIKE INDUCTOR COUPLING STRUCTURE

(75) Inventors: Ming-Wei Lee, Taichung County (TW); Chin-Li Wang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/033,893

(22) Filed: Feb. 20, 2008

(30) Foreign Application Priority Data
Dec. 10, 2007 (TW) 96147033

(51) Int. Cl. H01F 5/00

(52) U.S. Cl. 336/200

(57) ABSTRACT

A planar-like inductor coupling structure includes a first planar inductor embedded in an insulating material layer and a second planar inductor also embedded in the insulating material layer. The first planar inductor and the second planar inductor are substantially at the same height, and have a portion in a horizontal distribution serving as a coupled overlapping region with electric insulation from each other. In addition, the first planar inductor and the second planar inductor may be at different heights.

### CROSS-REFERENCE TO RELATED APPLICATION

This application claims the priority benefit of Taiwan application serial no. 96147033, filed on Dec. 10, 2007. The entirety of the above-mentioned patent application is hereby incorporated by reference herein and made a part of this specification.

### BACKGROUND OF THE INVENTION

1. Field of the Invention

The present invention relates generally to a inductor coupling structure, especially relates to a planar-like inductor coupling structure.

2. Description of Related Art

With the developing trend of “light, thin, short, small,” and multi-function integration of electronic products, more and more circuit devices need to be integrated on a semiconductor chip, and a coupling mechanism between inductors becomes one of the indispensable devices in many semiconductor chip designs. No matter a signal conversion mechanism in various circuits, or a resonant cavity coupling in passive devices, the application of the coupling mechanism between inductors can be easily found.

For example, in an RF front-end circuit in a communication system, the filter is generally an indispensabile device, and the coupling mechanism between inductors is a common and an importance component in the filter design. The filter is usually disposed at the very front end of the system, for allowing signals of an operating band to pass through, and blocking signals of other bands, since the signals of other bands are regarded as noises relative to the system and may influence the communication quality.

In the planar circuits, for example, in an environment of micro-strip line or strip line, the filter design can be achieved in many manners. However, if the filter device needs to be integrated in a chip design, due to the limitation of the chip area, the architecture of a quarter wavelength resonant cavity usually employed in a planar circuit cannot be adopted in the filter design, and only the capacitors and inductors embedded in the chip can be used to implement the architecture of the filter. Therefore, it is the problem in a chip filter design in need of solution how to implement the coupling between filter resonant cavities.

FIG. 1 shows a conventional coupling circuit between filter resonant cavities. Referring to FIG. 1, the coupling circuit is achieved by a mechanism of inductor coupling 100 using two inductors. Since the coupling mechanism between two inductors in the chip design is hard to implement, a capacitor coupling 102 between filter resonant cavities in the chip design is an easy way to achieve the coupling mechanism. However, the area of the inductors embedded in a chip is much larger than that of the capacitors, so the capacitor coupling needs additional capacitor devices and additional connecting lines as well. Thus, the area of the filter design is increased, and also the additional connecting line effect must be taken into account in the filter design. Thus, if the inductors commonly adopted in the design of filter embedded in chip can produce a coupling mechanism and can achieve the easy adjustment of the coupling coefficient, the design of the filter embedded in chip will be easily implemented.

In the chip design, the planar spiral inductors are the most commonly used as the embedded inductors. However, since the number of metal layers in a semiconductor process is limited, the manners for producing a coupling mechanism between two embedded planar spiral inductors in a chip are limited. FIG. 2 shows a conventional spiral inductor coupling mechanism. Referring to FIG. 2, two planar spiral inductors 104, 106 are arranged in parallel without being overlapped with each other, so as to produce a coupling between the inductors. However, the strength of the coupling produced in FIG. 2 is weak. FIG. 3 shows another conventional spiral inductor coupling mechanism. Referring to FIG. 3, two planar spiral inductors 108, 110 are alternately wound for producing an inductor coupling mechanism. However, although the inductor coupling mechanism produced in the above manner has a larger coupling strength, the coupling strength may be too larger in some circumstances, which goes against the requirement of circuit design.

In addition to the aforementioned two manners, the inductor coupling may also be produced by perpendicularly stacking two planar spiral inductors. However, all of the above manners might have their defects and limitations in chip design.

The design of two adjacent inductors arranged in parallel has a disadvantage that, for example, the inductor coupling coefficient is not large. Thus, when the designed circuit, for example, a filter, needs a large coupling coefficient, the mechanism may not meet the requirement on the coupling coefficient. Meanwhile, the inductors occupy a large area of the chip, so the inductor coupling mechanism produced between two adjacent inductors arranged in parallel needs a large chip area.

The design of the inductor coils alternately wound occupies a less chip area, but the inductor coupling coefficient may be too large, and the inductance value and the coupling coefficient cannot be adjusted separately.

The design of the inductors perpendicularly stacked also occupies a less chip area, but the coupling coefficient may still be too large and cannot be adjusted freely. In addition, since the number of metal layers in a semiconductor is limited, the layout of perpendicularly stacking the inductors may result in a thinner conductive metal layer of a single inductor. Thus, the Q value of the inductor is severely reduced, which influences the characteristics of the circuit.

### SUMMARY OF THE INVENTION

Accordingly, exemplary examples consistent with the present invention disclose a planar-like inductor coupling structure, in which a coupling is generated by an overlapping region between chip inductors, which for example, substitutes the conventional coupling architecture of two inductors arranged in parallel, perpendicularly stacked, or alternately wound.

An exemplary example consistent with the present invention provides a planar-like inductor coupling structure, which includes a first planar inductor embedded in an insulating material layer and a second planar inductor also embedded in the insulating material layer. The first planar inductor and the second planar inductor are substantially at a same height, and have a portion in a horizontal distribution serving as a coupled overlapping region with electric insulation from each other. In addition, the first planar inductor and the second planar inductor may be at different heights.

An exemplary example consistent with the present invention also provides a planar-like inductor coupling structure, which includes a first planar inductor embedded in an insulating material layer and a second planar inductor also embedded in the insulating material layer. The first planar inductor and the second planar inductor are at different heights, and have a portion in a horizontal distribution serving as a coupled overlapping region with electric insulation from each other.

An exemplary example consistent with the present invention further provides a planar-like inductor coupling structure, which includes a first conductive layer, a second conductive layer, and a third conductive layer. The first conductive layer is in an insulating material layer and includes a first region and a second region, and the first and second regions have a partial overlapping region. The second conductive layer is in an insulating material layer and located on the first and second regions of the first conductive layer. The third conductive layer is in an insulating material layer and located on the second conductive layer, and respectively corresponding to the first and the second region. The third conductive layer is electrically connected to the second and the first conductive layer, so as to constitute a first planar inductor and a second planar inductor insulated from each other. Further, the layout of the first, second, and third conductive layers allows that the first and the second planar inductor are overlapped at an output end, an input end, and a intersection region, thereby achieving an insulation structure of a same total thickness.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 shows a conventional coupling circuit between filter resonant cavities.

FIG. 2 shows a conventional spiral inductor coupling mechanism.

FIG. 3 shows another conventional spiral inductor coupling mechanism.

FIG. 4A is a schematic view of a filter circuit according to an exemplary embodiment of the present invention.

FIG. 4B is a schematic view showing a structure of a filter circuit structure according to an exemplary embodiment of the present invention.

FIG. 5A is a schematic three-dimensional view showing a structure of a single planar spiral inductor according to an exemplary embodiment of the present invention.

FIG. 5B is a schematic top view of the single planar spiral inductor in FIG. 5A.

FIG. 5C is a schematic cross-sectional view of a semiconductor structure in FIG. 5A.

FIG. 6 is a schematic view showing a three-layered structure of a planar spiral inductor according to an embodiment of the present invention.

FIG. 7 is a schematic view showing a structure of two planar spiral inductors crossed and overlapped with each other according to an exemplary embodiment of the present invention.

FIG. 8 is a schematic top and cross-sectional view showing a structure of two planar spiral inductors crossed and overlapped with each other according to another exemplary embodiment of the present invention.

FIG. 9 is a schematic top view showing the exploded structure of two planar spiral inductors crossed and overlapped with each other according to another exemplary embodiment of the present invention.

FIG. 10 is a schematic view showing a coupling structure of three inductors according to an embodiment of the present invention.

FIG. 11 is a schematic view showing an inductor coupling effect according to an exemplary embodiment of the present invention.

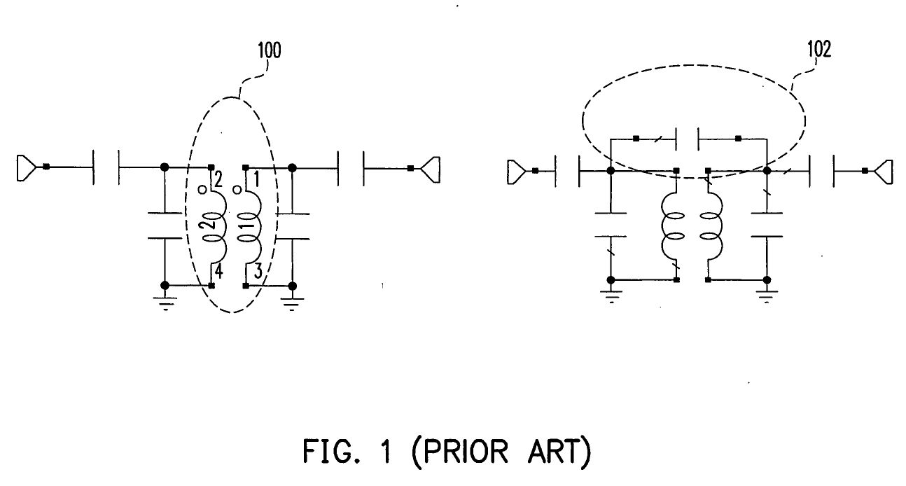

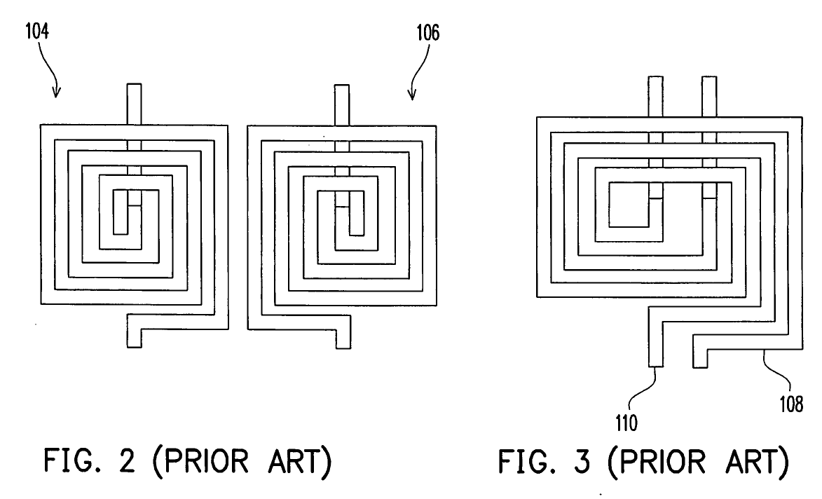

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The circuit layout between two inductors adopted in the coupling mechanism of the present invention is basically different from the conventional design. In the present invention, an overlapping region between two planar inductors serves as the major inductor coupling mechanism, and the dimension of the inductor overlapping region may be easily adjusted. The larger overlapping area between the two inductors causes the larger inductor coupling effect. Thus, the coupling effect may be adjusted according to the design requirement, and meanwhile the additional chip design space may be saved due to the overlapping between the inductors. This inductor coupling mechanism can avoid the problems of a too small or too large coupling effect in the design of two adjacent inductors arranged in parallel or perpendicularly stacked. Further, since the coupling effect of this inductor coupling mechanism can be controlled by the inductor overlapping region, and the inductance value and inductor coupling coefficient will not restrict each other. Therefore, the inductor coupling mechanism has better degree of freedom in design, no matter applied in various signal conversion mechanisms or filters in circuit design.

The present invention can at least effectively solve problems in the conventional chip inductor coupling mechanism that the coupling coefficient becomes too large, too small, or is difficult to control. In the filter design, compared with a filter structure with an additional capacitor coupling mechanism, the inductor coupling mechanism provided by the present invention can, for example, reduce the use of devices and connecting lines between chips, and the area of the filter.

The application of the filter is illustrated in some embodiments of the present invention, and the present invention will not be limited to this. Moreover, the present invention is not limited to the following embodiments. The embodiments below may also be suitably combined without limitation.

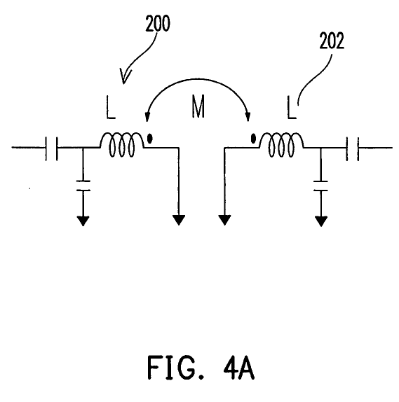

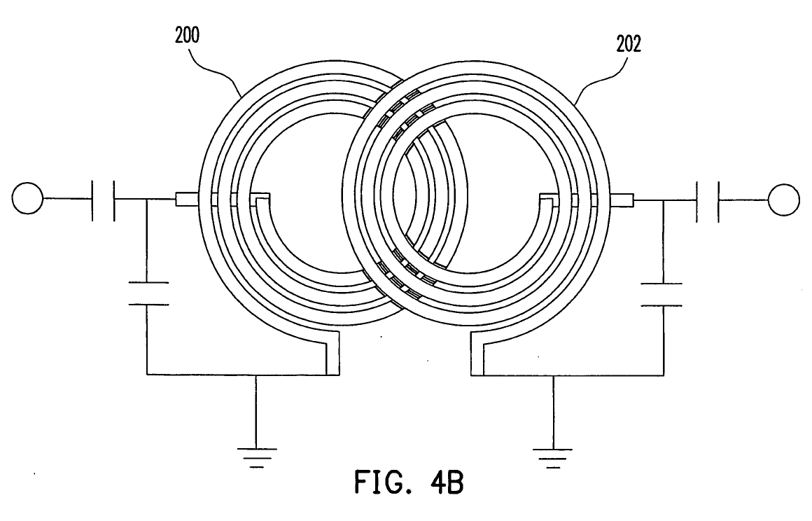

FIG. 4A is a schematic view of a filter circuit adopting an inductor coupling circuit according to an exemplary embodiment of the present invention. Referring to FIG. 4A, the filter circuit of the present invention is implemented by a coupling between two inductors 200, 202. A coupling strength M is generated by the overlapping of the two planar inductors 200, 202, and this structure may be formed simultaneously with an integrated circuit (IC) in a semiconductor process. The planar inductors 200, 202 are, for example, planar spiral inductors for illustration. However, the spiral shape is only a preferred manner, and other shapes of inductors may also be adopted, which will not be limited herein. Further, the overlapping and coupling of the inductors can also achieve the same purpose. In addition, different types of planar inductors may also be achieved by overlapping and coupling.

FIG. 4B is a schematic view showing a structure of a filter circuit designed based on a coupling structure of a planar spiral inductor according to an exemplary embodiment of the present invention. Referring to FIG. 4B, corresponding to the circuit in FIG. 4A, the inductor coupling structure fabricated in a semiconductor process includes two planar spiral inductors 200, 202 having a portion in a horizontal distribution serving as a coupled overlapping region. The two planar spiral inductors 200, 202 are overlapped but being electrically insulated from each other. Moreover, the overlapping portion may be changed according to the requirements without being limited to the structure of this embodiment.

Referring to FIG. 4B, the spiral inductors are inductors of a helical form, which is not limited to a circularly spiral shape as shown in the figure. Other spiral shapes, such as quadrangular, elliptical, and polygonal spiral may also be adopted. In addition, for example, two inductors are used in this embodiment, but more inductors may also be coupled depending on actual requirements.

Further, a planar inductor coupling mechanism is fabricated in a semiconductor process, and the two planar spiral inductors are, for example, embedded in a chip. Each inductor is formed by connecting two or more conductive metal layers and metal through-hole layers between the two or more conductive metal layers. The two inductors are placed on the same plane, and have an overlapping region in an axial direction of the inductor. At the overlapping portions of the two inductors, the first inductor is connected with a first conductive metal layer, the second inductor is connected with a second conductive metal layer, and the overlapping portions of the first and second inductors are isolated by a non-metal dielectric material. In other words, the planar spiral inductors are fabricated into a dielectric material layer in a semiconductor process.

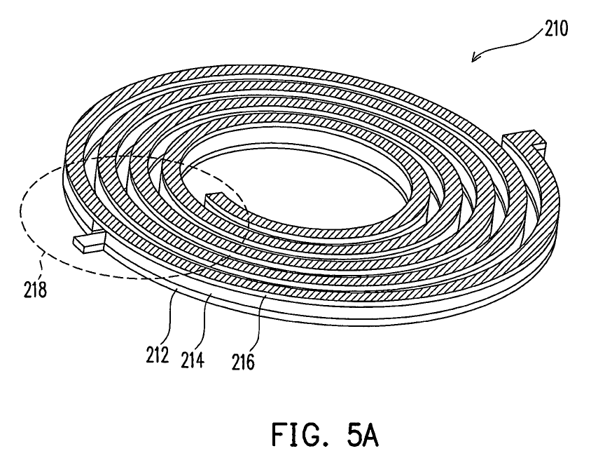

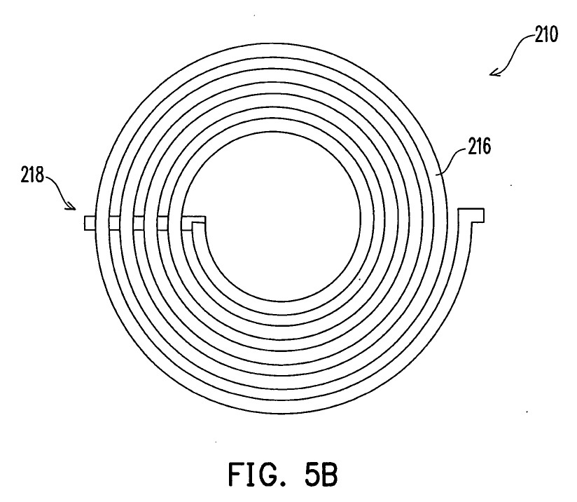

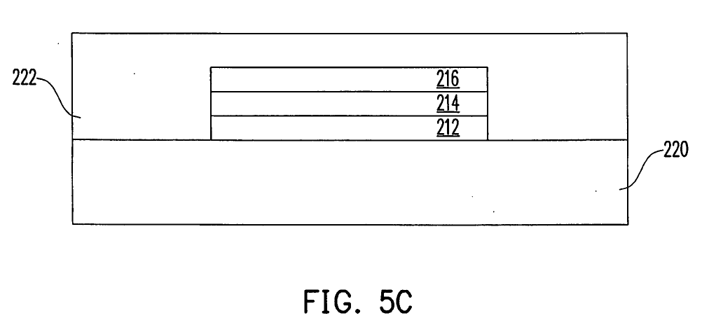

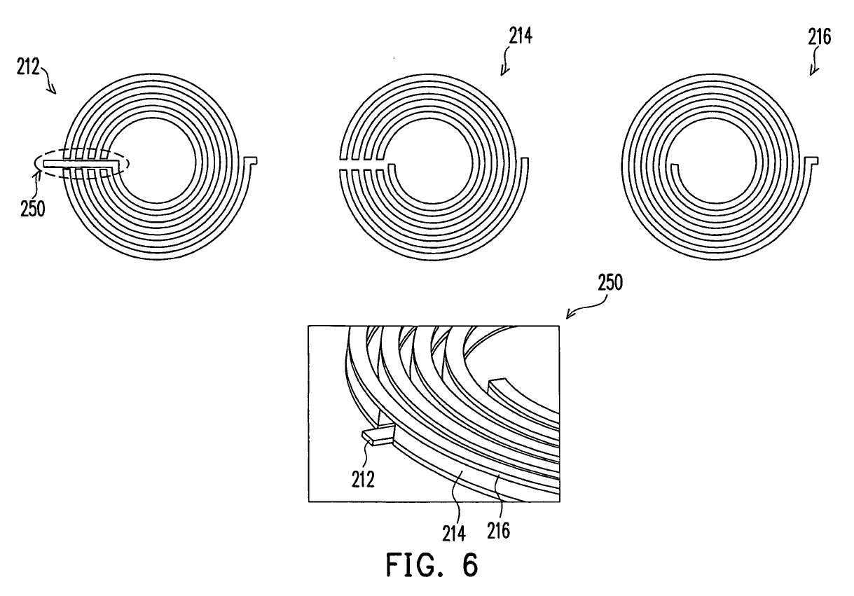

FIG. 5A is a schematic three-dimensional view showing a structure of a single planar spiral inductor according to an exemplary embodiment of the present invention. FIG. 5B is a schematic top view of the single planar spiral inductor in FIG. 5A. FIG. 5C is a schematic cross-sectional view of a semiconductor structure in FIG. 5A. Referring to FIGS. 5A, 5B, and 5C together, for a single planar spiral inductor 210, the thickness of the spiral wire thereof is determined by the desired Q value and parameters such as the area of the inductor. Preferably, the thickness of the spiral wire is achieved by three conductive layers 212, 214, 216, such that an end point 218 of the conductive layer 212 and the other end point of the conductive layer 216 maintain a planar structure. In order to achieve a planar spiral structure, the end point 218 is not connected to every spiral wire, so the structure of the middle conductive layer 214 provides isolation to achieve a spiral coil. The conductive layers 212, 214, 216 are formed on a substrate 220. The substrate 220 is, for example, a dielectric layer on a fabricated semiconductor IC. The conductive layers 212, 214, 216 are fabricated by, for example, a photolithography and etching process for fabricating interconnects, and are embedded in a dielectric layer 222. According to the semiconductor process, the dielectric layer 222 has a multi-layered structure in accordance with the requirements of the processes such as deposition, photolithography and etching of the conductive layers 212, 214, 216, and provides insulating and flattening functions. The semiconductor manufacturing method is known to those of ordinary skill in the art, and the details will not be described herein again.

FIG. 6 is a schematic view showing a three-layered structure of a planar spiral inductor according to an exemplary embodiment of the present invention. Referring to FIG. 6, for the structure having three conductive layers, in order to obtain the spiral wires wound without influencing the planar structure of the input/output (IO) ends, the structures of the three conductive layers 212, 214, 216 are not completely identical. For example, the conductive layer 212 at the bottom has a bent IO portion 250, serving as a connecting portion extending from the interior of the spiral inductor to the outside. The middle conductive layer 214 is used to increase the thickness of the inductor. Further, a gap of the spiral wire of the conductive layer 214 isolates the upper and lower spirals 212, 216. The upper conductive layer 216 is, for example, a whole spiral wire. The amplified structure of the bent portion 250 is shown in a three-dimensional view.

In other words, the above multi-layered structure makes it easier to lead out the IO ends, so as to achieve a planar structure. However, the present invention is not limited to the aforementioned structure.

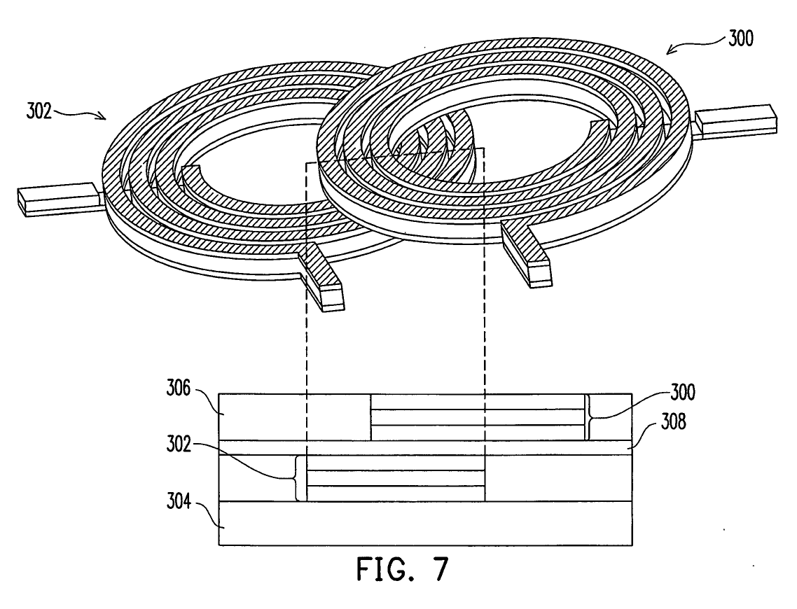

FIG. 7 is a schematic view showing the structure of two planar spiral inductors crossed and overlapped with each other according to an exemplary embodiment of the present invention. Referring to FIG. 7, two planar spiral inductors 300, 302 are, for example, formed in the above manner. However, the two planar spiral inductors 300, 302 have a coupled overlapping region d. A corresponding cross-sectional structure of the two inductors is shown in a lower figure, including the coupled overlapping region d. In this embodiment, the two planar spiral inductors 300, 302 are, for example, placed on different planes for illustration. The two planar spiral inductors 300, 302 are embedded in a dielectric layer 306, and are isolated by a dielectric layer 308 in a perpendicular direction. The dielectric layer 308 may also serve as a base material surface for the subsequent process of forming the planar spiral inductor 300. In addition, the planar spiral inductor 302 is fabricated, based on the substrate 304.

The above two planar spiral inductors 300, 302 are, for example, two identical inductors. However, the above two inductors have many variations for example, thicknesses, dimensions, line widths, line pitches, number of turns, and spiral shapes according to actual design requirements.

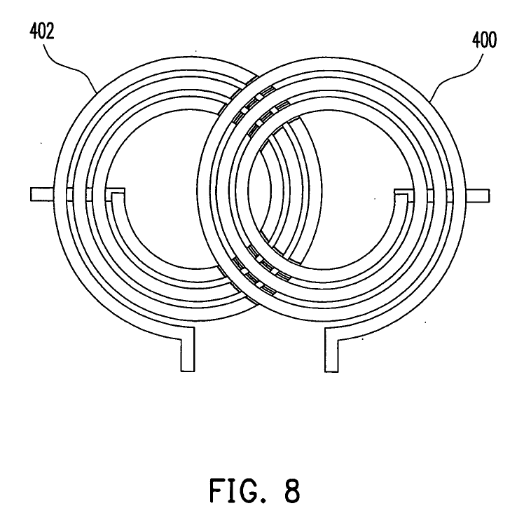

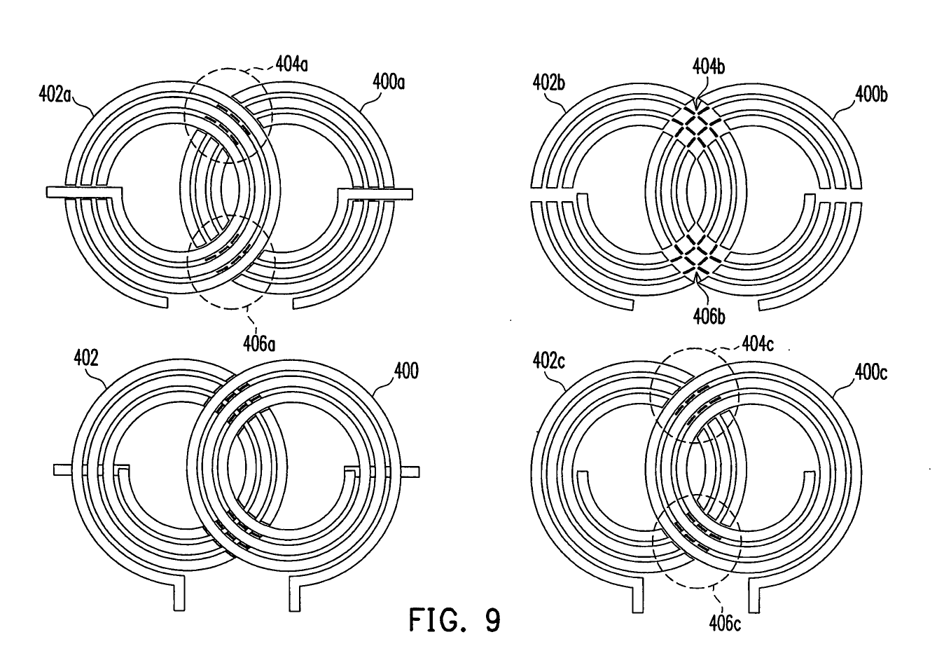

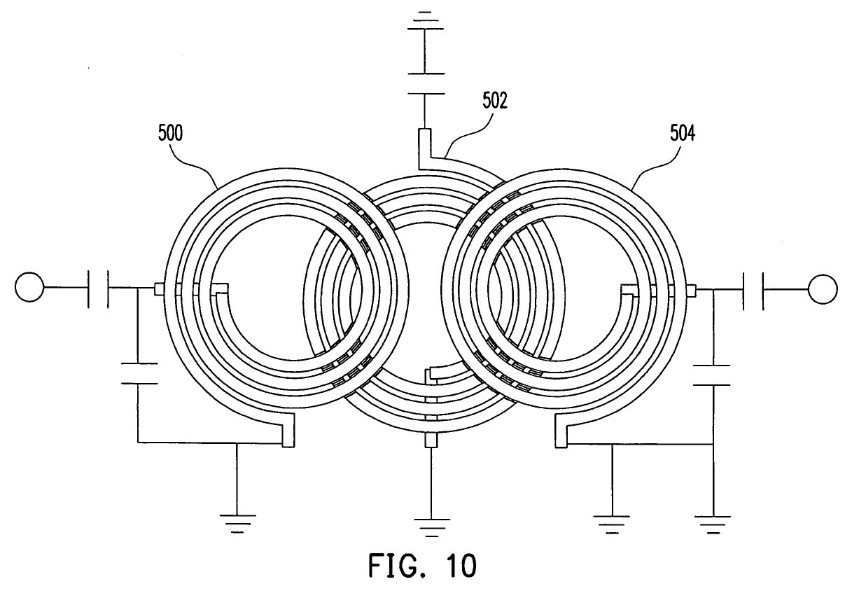

In the structure of FIG. 7, the coupled overlapping region d is not directly crossed and overlapped, so the process is relatively easier. However, the total thickness of the two inductors is larger, and more semiconductor metal processes are needed. In order to maintain a smaller thickness and avoid using additional semiconductor metal processes, the coupled overlapping region need to be crossed and overlapped in height. FIG. 8 is a schematic top and cross-sectional view showing the structure of two planar spiral inductors crossed and overlapped with each other according to another exemplary embodiment of the present invention. Referring to FIG. 8, two planar spiral inductors 400, 402 are substantially formed on the same plane. Seen from a cross-sectional view of FIG. 9, the two planar spiral inductors 400, 402 in this embodiment, for example, have the same height and thickness. The IO ends may have a multi-layered structure according to the above embodiments. Moreover, the coupled overlapping region may also have such multi-layered structure.

FIG. 9 is a schematic top view showing the exploded structure of two planar spiral inductors crossed and overlapped with each other according to another exemplary embodiment of the present invention. Referring to FIG. 9, the two planar spiral inductors 400, 402 are shown in the lower left figure. The two planar spiral inductors 400, 402 are crossed and overlapped but being electrically insulated from each other. The bottom conductive layers include two portions 400a, 402a of the conductive layers of the two planar spiral inductors 400, 402 respectively. Since the two planar spiral inductors 400, 402 must be insulated from each other, the crossed overlapping regions 404a, 406a must be suitably isolated. For example, the spiral wire of the conductive layer 400a is fabricated by segments. Next, the middle conductive layers include two portions 400b, 402b. The two portions of conductive layers 400b, 402b need to be isolated from each other either, but correspondingly contact the bottom conductive layers 400a, 402a. Here, for example, the crossed overlapping regions 404b, 406b do not have spiral wires, and only have dielectric material layers. The wires in the crossing overlapping regions 404b, 406b are corresponding to the spacing of the spiral wires of the crossed overlapping regions 404a, 406a, and may be not necessary in option. Then, the top conductive layers 400c, 402c are correspondingly connected at the junctions of the conductive layers 400a, 402a, 400b, 402b. For the conductive layers 400c, 402c, the conductive layer 400c is a continuous spiral wire, and the conductive layer 402c is formed by segments. The above three conductive layers are to form the two planar spiral inductors 400, 402 in stack and insulating from each other.

The structure of the above three conductive layers is fabricated in the common semiconductor process. If the semiconductor process is altered, the structure of the two planar spiral inductors 400, 402 may also be changed, which is not limited to a certain structure. However, according to an embodiment of the present invention, the crossed overlapping regions and desired IO ends are able to maintain a planar structure.

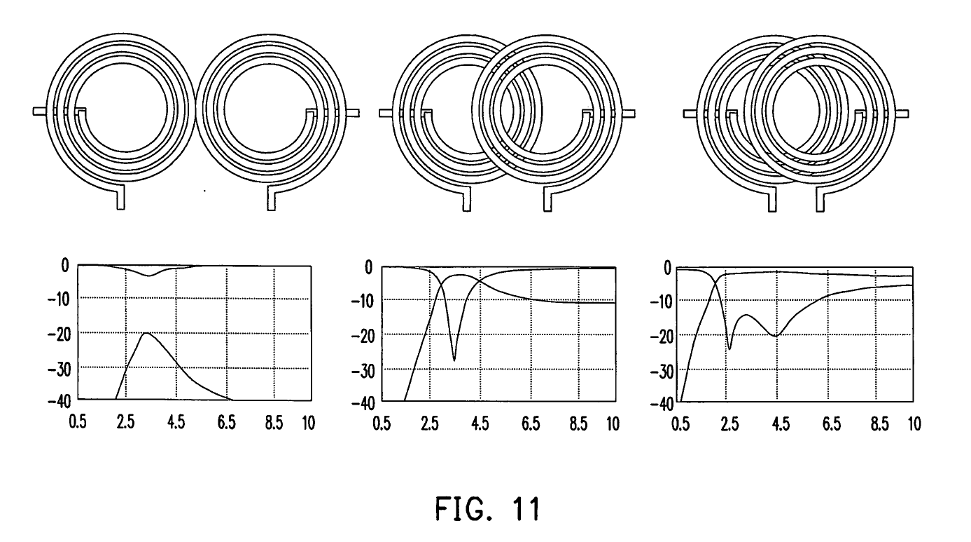

FIG. 10 is a schematic view showing a coupling structure of three inductors according to an exemplary embodiment of the present invention. Referring to FIG. 10, in practice, a circuit may require more coupled inductors. For example, in FIG. 10, a circuit having three coupled inductors 500, 502, 504 is shown. In the above manner, a desired coupling strength may be achieved through a coupled overlapping mechanism, and in conjunction, the external semiconductor capacitors are fabricated to implement, for example, a filter circuit. As for the coupling structure of the three inductors 500, 502, 504, the inductor 502 is respectively coupled with the inductors 500, 504, which can be achieved in the above manner. Moreover, the three inductors 500, 502, 504 are electrically insulated, but magnetically coupled with each other. The three inductors 500, 502, 504 may be placed on the same plane or on different planes. Any two of the three inductors are placed on the same plane, while the other inductor is placed on a different plane. Above are also the variations in design.

The embodiments of the present invention achieve the coupling effect by the overlapping of inductors. The extent of overlapping may change the coupling strength, so as to obtain a desired coupling strength. The present invention also verifies the impact of the change of the coupled overlapping region on the frequency. FIG. 11 is a schematic view showing an inductor coupling effect according to an exemplary embodiment of the present invention. Referring to FIG. 11, two inductors are taken as an example for verification. The coupled overlapping region does not exit on the left. Seen from the corresponding figure below, the filter level is at −5 db, and no bandwidth can be used. A proper coupled overlapping region exists in the middle, and the bandwidths within a proper range are obtained. A too large coupled overlapping region exists on the right, and the over large bandwidths are obtained. Therefore, the coupling strength is determined by the dimension of the coupled overlapping region without changing the process.

According to the present invention, the planar inductor coupling mechanism applied in the semiconductor process has a simple structure but clear function. The present invention provides an easily adjustable inductor coupling mechanism and reduces the circuit area without affecting the semiconductor process and maintaining the Q value of the inductors. The planar inductor coupling mechanism of the present invention applied in the semiconductor process has a high industrial application value.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A planar-like inductor coupling structure, comprising:
a first planar inductor, embedded in an insulating material layer; and
a second planar inductor, embedded in the insulating material layer, wherein the first and second planar inductors are substantially at a same height, and have a portion in a horizontal distribution serving as a coupled overlapping region with electric insulation from each other.

2. The planar-like inductor coupling structure according to claim 1, wherein the first planar inductor is of a thickness, and is composed of at least one conductive layer.

3. The planar-like inductor coupling structure according to claim 1, wherein the second planar inductor has a thickness, and is composed of at least one conductive layer.

4. The planar-like inductor coupling structure according to claim 1, wherein the first and second planar inductors have a substantially same thickness, and are respectively composed of at least one conductive layer.

5. The planar-like inductor coupling structure according to claim 4, wherein at least one of the first and the second planar inductor includes three conductive layers.

6. The planar-like inductor coupling structure according to claim 1, further comprising at least a third planar inductor having a second coupled overlapping region with at least one of the first and the second planar inductor in the horizontal distribution.

7. The planar-like inductor coupling structure according to claim 6, wherein the third and the first planar inductor are substantially at a same height.

8. The planar-like inductor coupling structure according to claim 1, wherein at least one of the first and the second planar inductor is a planar spiral inductor.

9. A planar-like inductor coupling structure, comprising:
a first planar inductor, embedded in an insulating material layer; and
a second planar inductor, embedded in the insulating material layer, wherein the first and second planar inductors are at different heights, and have a portion in a horizontal distribution serving as a coupled overlapping region with electric insulation from each other.

10. The planar-like inductor coupling structure according to claim 9, wherein the first planar inductor is of a thickness, and is composed of at least one conductive layer.

11. The planar-like inductor coupling structure according to claim 9, wherein the second planar inductor is of a thickness, and is composed of at least one conductive layer.

12. The planar-like inductor coupling structure according to claim 9, wherein the first and second planar inductors have a substantially same thickness, and are respectively composed of at least one conductive layer.

13. The planar-like inductor coupling structure according to claim 12, wherein at least one of the first and the second planar inductor includes three conductive layers.

14. The planar-like inductor coupling structure according to claim 9, further comprising at least a third planar inductor, forming a second coupled overlapping region with at least one of the first and the second planar inductor in the horizontal distribution.

15. The planar-like inductor coupling structure according to claim 14, wherein the third and the first planar inductor are at different heights.

16. The planar-like inductor coupling structure according to claim 9, wherein at least one of the first and the second planar inductor is a planar spiral inductor.

17. A planar-like inductor coupling structure, comprising:
a first conductive layer, in an insulating material layer, wherein the first conductive layer comprises a first region and a second region, and the first and second regions have a partial overlapping region;
a second conductive layer, in the insulating material layer and located on the first and second regions of the first conductive layer; and
a third conductive layer, in the insulating material layer and located on the second conductive layer while respectively corresponding to the first and the second region, wherein the third conductive layer is electrically connected to the second and the first conductive layers, so as to form a first planar inductor and a second planar inductor insulated from each other;
wherein through a layout of the first, second, and third conductive layers, the first and the second planar inductor are overlapped with each other at an output end, an input end, and an intersection region, thereby achieving an insulation structure with a same total thickness.

18. The planar-like inductor coupling structure according to claim 17, wherein the first conductive layer, the second conductive layer, the third conductive layer, and the insulating material layer constitute a semiconductor structural layer in a dielectric structural layer.

19. The planar-like inductor coupling structure according to claim 17, wherein the first conductive layer further comprises a third region overlapped and coupled with at least one of the first and the second region.

20. The planar-like inductor coupling structure according to claim 17, wherein at least one of the first and the second planar inductor is a planar spiral inductor.
